(19) United States
(12) Patent Application Publication
(10) Pub. No.: US 2014/0163438 A1
(43) Pub. Date: Jun. 12, 2014

(54) VIBRATION MODULE FOR MASSAGING SKIN

(71) Applicants: Changman Park, Seoul (KR); Chilsung Lee, Suwon-si (KR); Changkeun Lee, Seoul (KR); Taehong Shin, Seoul (KR); Seunghwan Yi, Seoul (KR); Cheonghwan Hwang, Seoul (KR); Wooram Park, Seoul (KR); Kyungshin Park, Seoul (KR); Jeongmin Lee, Suwon-si (KR); Byungyoung Kang, Seoul (KR)

(72) Inventors: Changman Park, Seoul (KR); Chilsung Lee, Suwon-si (KR); Changkeun Lee, Seoul (KR); Taehong Shin, Seoul (KR); Seunghwan Yi, Seoul (KR); Cheonghwan Hwang, Seoul (KR); Wooram Park, Seoul (KR); Kyungshin Park, Seoul (KR); Jeongmin Lee, Suwon-si (KR); Byungyoung Kang, Seoul (KR)

(73) Assignees: SENTRONIX CO., LTD, Suwon-si (KR); AMOREPACIFIC CORPORATION, Seoul (KR)

(21) Appl. No.: 14/232,545

(22) PCT Filed: Jul. 13, 2012
(86) PCT No.: PCT/KR2012/005573

§ 371 Date: Jan. 13, 2014

(30) Foreign Application Priority Data
Jul. 13, 2011 (KR) 20-2011-0006379

(51) Int. Cl. A61H 23/02

(52) U.S. Cl. CPC A61H 23/02
USPC 601/46

(57) ABSTRACT

Disclosed is a vibration module for skin massage having minimized volume and thickness and securing flexibility by which a PCB on which a vibrator and a drive of the vibrator, a controller are mounted and a battery are integrally attached to a supporting plate, for transmitting vibration to human skin relatively wide can be transmitted to the human skin, and having improved mobility. The vibration module includes a PCB; a vibrator installed on the PCB; a drive providing vibration force; a controller controlling the drive; a battery supplying the electric power to the drive and the controller; a supporting plate connecting the printed circuit board to the battery; a power connecting member electrically connecting power terminals of the battery to power terminals of the drive; and an insulator to allow contact between the power terminals and the power connecting member at the separation from the battery.

### CROSS REFERENCE RELATED APPLICATION

This application claims foreign priority of Korean Patent Application No. 2010-272071, filed on Dec. 6, 2010, which is incorporated by reference in its entirety into this application.

### BACKGROUND OF THE INVENTION

1. Field of the Invention

The present invention relates to a vibration module for skin massage, and more particularly, to a vibration module for skin massage having minimized volume and thickness and securing flexibility by which a printed circuit board on which a vibrator and a drive of the vibrator, a controller of the vibrator are mounted and a battery are integrally attached to a flexible supporting plate, for transmitting vibration to an area on human skin relatively wider than the vibrator by which vibration of the vibrator can be transmitted to the human skin through whole vibration of the vibration module, and having improved mobility.

2. Description of the Related Art

Human's desire for beauty is not basic instinct, so desires for clean and beautiful skin have made various efforts to manage skin and maintain youth along with human history.

Even in this country, ancient biblical references and relics said that various efforts for beauty have been made and recent desires for beauty are stronger such that interests for cosmetic culture are stronger regardless of girls and boys.

In addition, as described above, skin is a very importance object in desires to be a beauty and particularly face skin is one of importance factors determining a beautify appearance and a factor of affecting looks deeply.

Thus, regardless of gender or ages, most people give efforts to protect and manage their skin and various goods helpful to skin care are provided in order to satisfy these efforts. For example, there are many good for the face skin care such as moisturizing cosmetics, moisture cream for face, cosmetic mask, etc.

Among the cosmetics, women especially prefer patches among the cosmetics as one of cosmetic tools because of features of maintaining wet face skin and making elastic face skin. The patches are classified into portional patches and whole patches (usually called as a cosmetic mask and a mask pack and hereinafter referred to as a “cosmetic mask”), wherein the cosmetic masks are made in the form of coating liquid cosmetics on a sheet covering face.

Moreover, in spite of simply applying cosmetics to skin or sticking the cosmetic mask to face such that cosmetics are absorbed by face skin itself, provided are devices to improve absorption of effective components of the cosmetic mask or cosmetics applied to skin by applying a bit of physical stimulation or vibration to the skin.

FIG. 1 shows an existing device (hereinafter, referred to as a “skin stimulation device”) applying artificial stimulating to human face skin such that effective components of the cosmetic mask or cosmetics are easily absorbed into the face skin, and as illustrated in FIG. 1 the existing skin stimulation device includes a patch 10, a skin contact unit 20, and a vibrator 30.

The patch 10 is attached to a local portion of a face and the size and the number thereof to be attached to the face are not limited.

The skin contact unit 20 is made of silicone-based material to be attached at least to any portion of the area to which the patch 10 is not attached and has an adhesive force due to silicon-based material.

The vibrator 30 includes a power supply 40 and a vibration generating unit 31, wherein a silicon-based adhesive unit is attached to the lower side of the vibration generating unit 31. The vibration generating unit 31 generates vibration using revolutions of a motor, use the existing technology of generating vibration, and preferably has rotational speed of 9,000 rpm to 15,000 rpm.

Operations of the existing skin stimulation device configured as described above will be described. After the patch is attached to a desired portion of user's face to which vibration is applied the skin contact unit is attached to the portion of the user's face while the patch is placed at the lower side thereof. Then, a user attaches the adhesive unit of the vibrator to a region of the skin contact unit on which the patch is placed and an electric power is supplied to the vibrator such that vibration is transmitted to the patch and the face skin. In this case, since the adhesive unit and the skin contact unit of the vibrator are made of silicon-based material to be attached to each other, the user's hands may be free from the vibrator.

However, the vibration generating unit and the power supply are connected to each other by a preset length of wires in the existing skin stimulation device. Thus, since the vibration generating unit cannot be operated independently, the skin stimulation device should be equipped with the power supply and for this reason is big in size and volume so that it is inconvenient to carry. Moreover, only a relatively small vibration generating unit actually participates in applying stimulation to face skin but the other most portions thereof do not associate with the stimulation. Thus, the stimulation can be applied only to a relatively narrow region on the face skin near the vibration generating unit and a large number of vibration generating units is required to apply stimulation to a relatively wide area of the face skin.

In addition, the existing skin stimulation device has the power supply of a relatively complex configuration and a relatively large volume because the existing skin stimulation device includes a separated switch switching the power supply on/off and supplies electric power to the vibrator by switching on/off of the switch. If the switch is omitted for the purpose of preventing this problem, a power jack of the vibrator must be separated from the power supply in order to stop the operation of the vibrator.

Furthermore, since the vibration generating unit is able to adjust intensity of the skin stimulation according to RPM of the motor, the existing skin stimulation device cannot provide various functions for skin massage.

### BRIEF SUMMARY OF THE INVENTION

The present invention has been made to overcome the above problem and provide a vibration module for skin massage in which a printed circuit board on which a vibrator and a drive thereof and a controller of the drive are installed and a battery are integrally attached to be connected to each other to a flexible supporting plate such that a volume and thickness of a vibration module can be minimized and flexibility thereof can be guaranteed and that whole vibration can be transmitted from the vibrator to human skin resulting in transmitting vibration to a relatively wide region of the human skin in comparison to the size of the vibrator.

The present invention also provides a vibration module for skin massage in which a power supply of a drive driving the vibrator includes thin terminals and a sheet insulator switch so as to exclude a complex switch having a manipulator such as buttons so that the simple configuration and minimum volume thereof can be achieved and in which the electric power can be supplied to the drive of the battery by switching of an insulator so that the battery is spent only when the vibrator is driven.

The present invention also provides a vibration module for skin massage in which various vibrations of the vibrator, in addition to the simple strong and weak vibrations, can be generated to improve skin massage effect by a controller controlling the drive of the vibrator using pulse width modulation (PWM).

The present invention also provides a vibration module for skin massage securing flexibility thereof to be easily bent along the contour of user's face and to be closely attached to the face resulting in improving transmission of vibration to the skin.

The present invention also provides a vibration module for skin massage in which a vibration transmission region is relatively increased due to transmission of vibration through whole the vibration module and overall volume of which is relatively reduced, resulting in improving mobility.

In order to achieve the foregoing and/or other aspects of the present invention, there is provided a vibration module for skin massage, including: a printed circuit board; a vibrator installed on the printed circuit board; a drive mounted on the printed circuit board to provide vibration force of the vibrator when electric power is supplied; a controller controlling the drive to control the vibration of the vibrator; a battery supplying the electric power to the drive and the controller; a supporting plate integrally connecting the printed circuit board to the battery; a power connecting member electrically connecting power terminals of the battery to power terminals of the drive mounted on the printed circuit board; and an insulator attached to a contact area between the power terminals of the battery and the power connecting member to allow contact between the power terminals and the power connecting member at the separation from the battery.

The supporting plate is made of flexible material.

Moreover, the battery and the vibrator are mounted at the ends in the major axis on an oval side of the supporting plate, respectively to be fixed on the supporting plate and to increase flexibility of the vibration module.

The controller controls the drive in pulse width modulation such that at least two different pulses are outputted to the drive, wherein the at least two different pulses are sequentially outputted by a preset reference or only one of the at least two different pulses is outputted continuously.

The printed circuit board has battery holes and a vibrator hole for insertion and fixing of the battery and the vibrator, and at least a part of the battery is inserted into and fixed in the battery holes and at least a part of the vibrator is inserted into and fixed in the vibrator hole.

The printed circuit board has power terminals for supplying electric power to the drive.

The insulator is made in the form of a sheet and is detachably attached to the battery to screen the power terminals.

Moreover, the vibration module further includes a buffering pad attached to a side of the supporting plate to prevent direct contact between the vibrator and the human skin.

The printed circuit board is a flexible printed circuit board (FPCB).

The drive is one of a vibration motor, a solenoid, a piezo device, and a linear vibrator.

According to the vibration module for skin massage of the present invention, the printed circuit board on which the vibrator and the drive thereof and the controller of the drive are installed and the battery are integrally attached to be connected to each other to the flexible supporting plate such that a volume and thickness of the vibration module can be minimized and flexibility thereof can be guaranteed and that whole vibration can be transmitted from the vibrator to human skin resulting in transmitting vibration to a relatively wide region of the human skin in comparison to the size of the vibrator.

Moreover, the power supply of the drive driving the vibrator includes thin terminals and a sheet insulator switch so as to exclude a complex switch having a manipulator such as buttons so that the simple configuration and minimum volume thereof can be achieved and the electric power can be supplied to the drive of the battery by switching of an insulator so that the battery is spent only when the vibrator is driven.

In addition, various vibrations of the vibrator such as rubbing, picking, pressing, and knocking similar to massage carried out by human hands, in addition to the simple strong and weak vibrations, can be generated to improve skin massage effect by a controller controlling the drive of the vibrator using pulse width modulation (PWM).

Furthermore, the vibration module for skin massage secures flexibility thereof to be easily bent along the contour of user's face and to be closely attached to the face resulting in improving transmission of vibration to the skin.

Furthermore, a vibration transmission region is relatively increased due to transmission of vibration through whole the vibration module and overall volume thereof is relatively reduced, resulting in improving mobility.

### BRIEF DESCRIPTION OF THE DRAWINGS

The objects, features and advantages of the present invention will be more apparent from the following detailed description in conjunction with the accompanying drawings, in which:

FIG. 1 is a perspective view illustrating an existing vibration device for skin massage;

FIG. 2 is a perspective view illustrating a vibration module for skin massage according to an exemplary embodiment of the present invention;

FIG. 3 is a side view illustrating the vibration module for skin massage according to the exemplary embodiment of the present invention;

FIGS. 4A to 4I are views showing massage operations of a vibrator of the vibration module for skin massage according to the exemplary embodiment of the present invention which vibrates in different types according to output pulses from a controller; and

FIG. 5 is a rear side view illustrating the vibration module for skin massage according to the exemplary embodiment of the present invention.

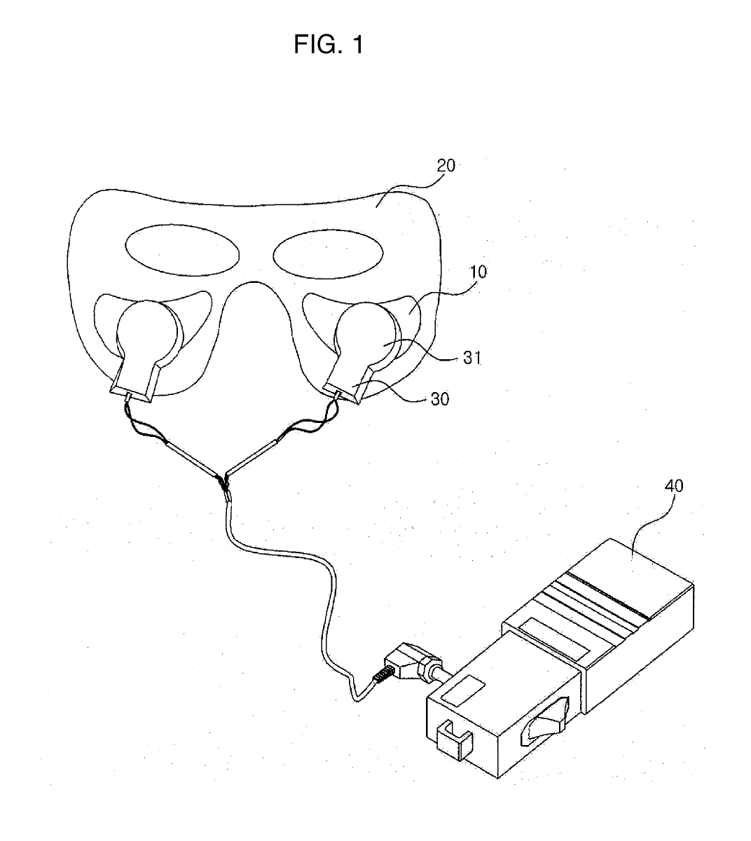

### DETAILED DESCRIPTION OF THE INVENTION

Hereinafter, a vibration module for skin massage according to an exemplary embodiment of the present invention will be described in detail with reference to the accompanying drawings.

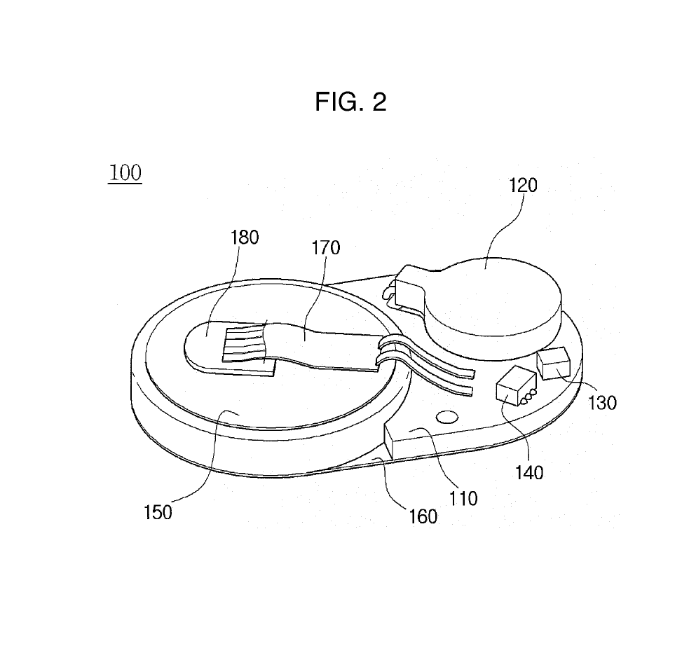

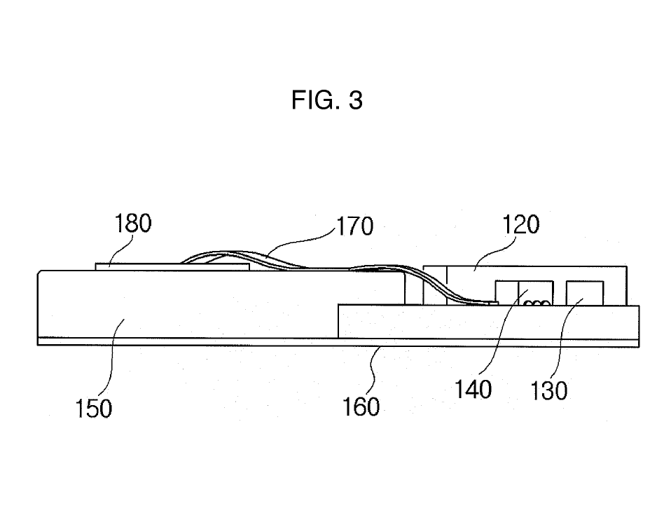

FIG. 2 is a perspective view illustrating a vibration module for skin massage according to an exemplary embodiment of the present invention. FIG. 3 is a side view illustrating the vibration module for skin massage according to the exemplary embodiment of the present invention.

As illustrated, a vibration module for skin massage 100 according to an exemplary embodiment of the present invention includes a printed circuit board 110, a vibrator 120, a drive 130, a controller 140, a battery 150, a supporting plate 160, a power connecting member 170, and an insulator 180.

The printed circuit board 110 is configured such that the vibrator 120 is installed on a side thereof and the drive 130 and the controller 140 are mounted thereon. Thus, the printed circuit board 110 has a circuit pattern for electrical connection between the battery 150, the drive 120, and the controller 130. The printed circuit board 110 may be a flexible printed circuit board (FPCB) for the purpose of allowing the vibration module 100 being bent along contours of a user's face and closed attached thereto.

The vibrator 120 is installed on the printed circuit board 110 and vibrates by receiving an electric power by the driver 130. The vibrator 120 is a device stimulating user's skin with vibration therefrom. That is, the vibrator 120 is not only a device of the vibration module for skin massage 100 directly performing skin massage but also a device transmitting power for the skin massage to the whole vibration module for skin massage 100. The vibrator 120 may be inserted into vibrator holes 160a formed in the printed circuit board 110 and the supporting plate 160.

This is because of reduction of overall thickness of the vibration module for skin massage 100, and in other words, the overall thickness of the vibration module for skin massage 100, when the vibrator 120 is installed on a side of the printed circuit board 110, becomes sum of the thickness of the vibrator 120 and the thicknesses of the printed circuit board 110 and the supporting plate 160. Thus, the vibrator holes 160a are formed in the printed circuit board 110 and the supporting plate 160 and the vibrator 120 is inserted into the vibrator holes 160a and the thicknesses of the printed circuit board 110 and the supporting plate 160 is subtracted from the overall thickness of the vibration module for skin massage 100 so that the overall thickness of the vibration module for skin massage 100 can be reduced.

The drive 130 is mounted on the printed circuit board 110 and received electric power from the battery 150 to supply the received electric power to the vibrator 120. The drive 130 may be any one of a vibration motor, a solenoid, a piezo device, and a linear vibrator.

The controller 140 is mounted on the printed circuit board 110 and controls the drive 130 to adjust vibration of the vibrator 120. The controller 140 controls the drive 130 in pulse width modulation (PWM). That is, the controller 140 operates the drive 130 in various modes through the PWM, while outputting at least two different pulses wherein the different output pulses are sequentially outputted or only a preset one type pulse is continuously outputted. The vibrator 120 may vibrate to provide various massage functions such as appeasing, rubbing, picking, pressing, knocking, etc., according to the various output pulses and the operating conditions of the drive 130.

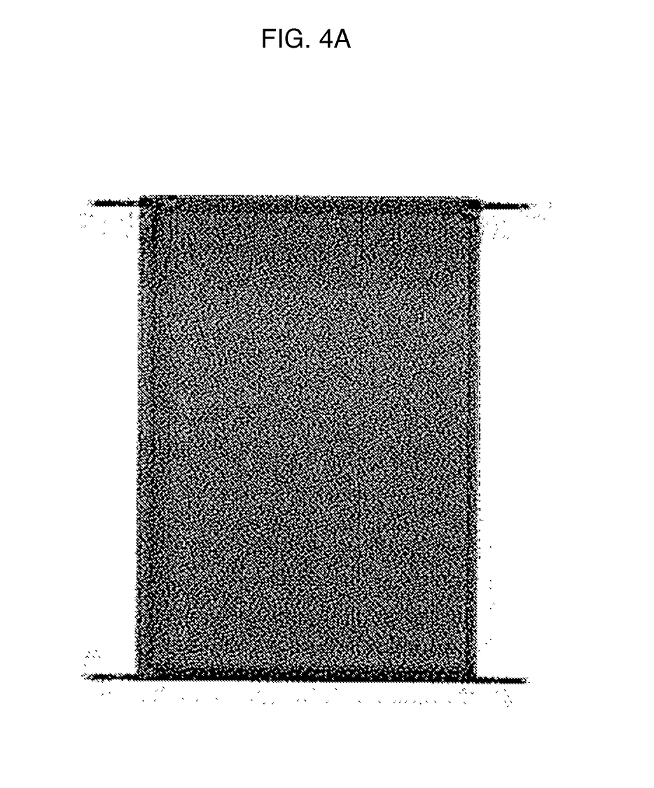

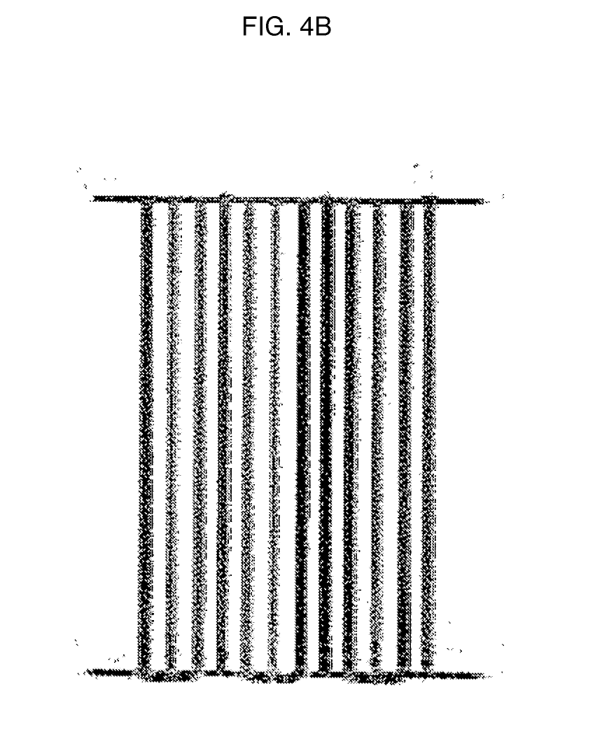

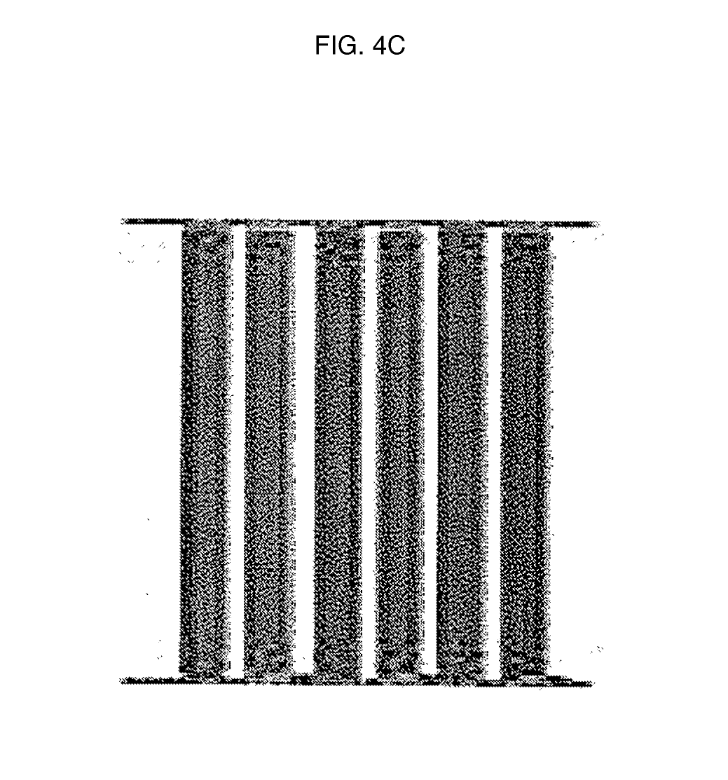

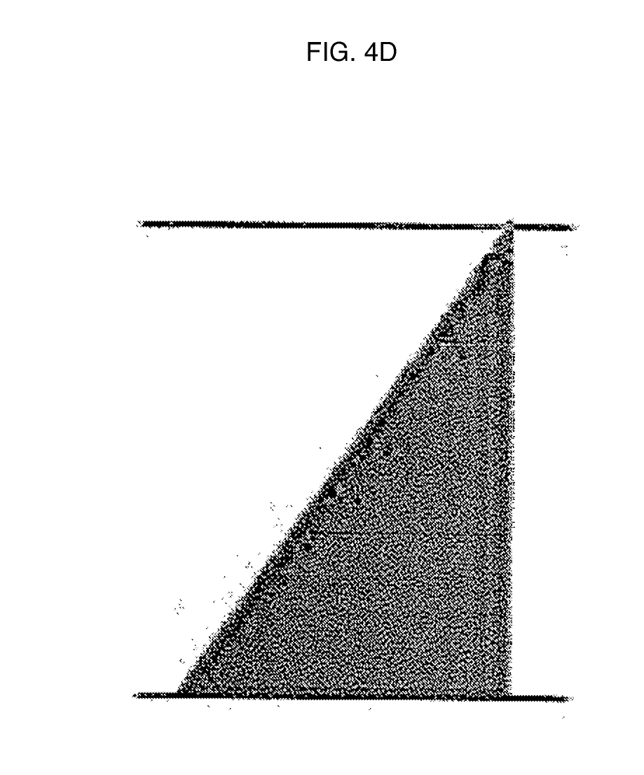

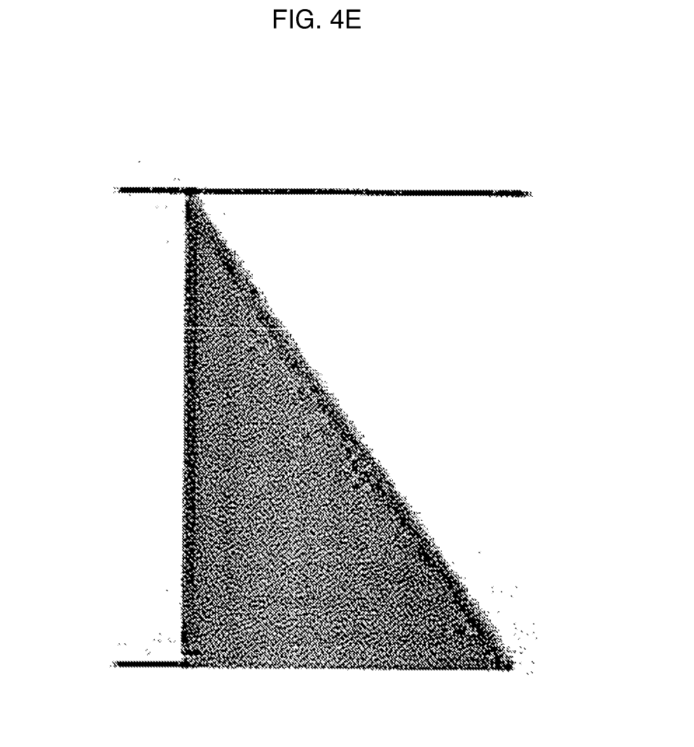

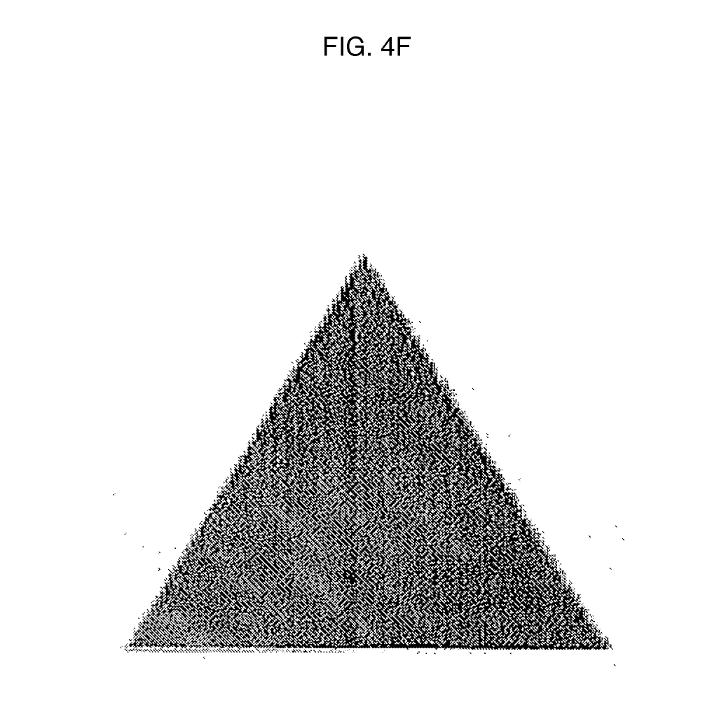

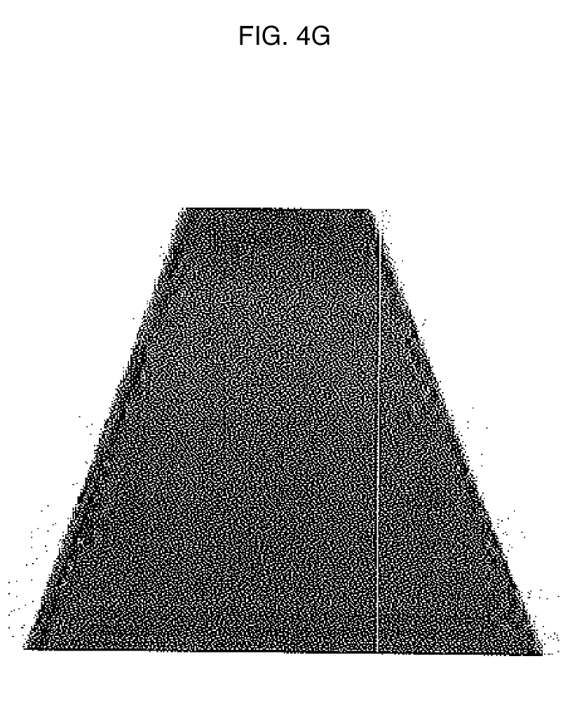

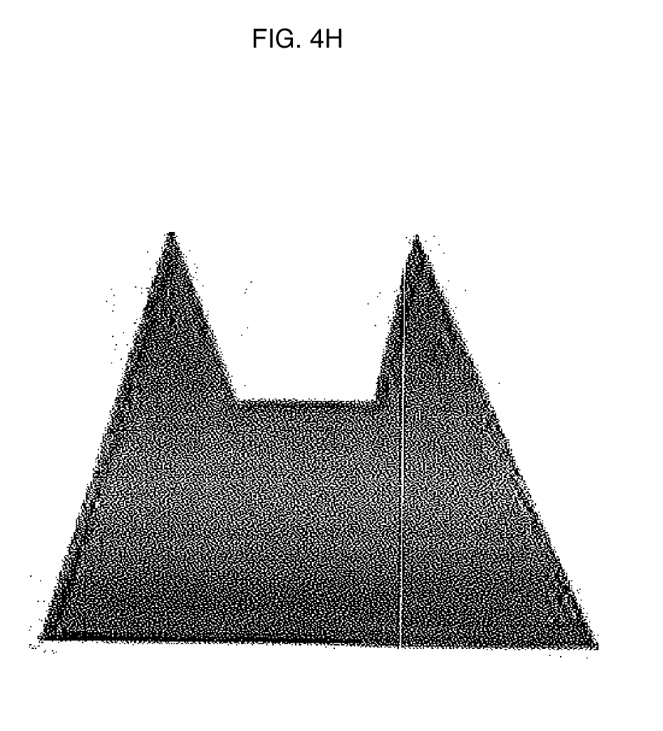

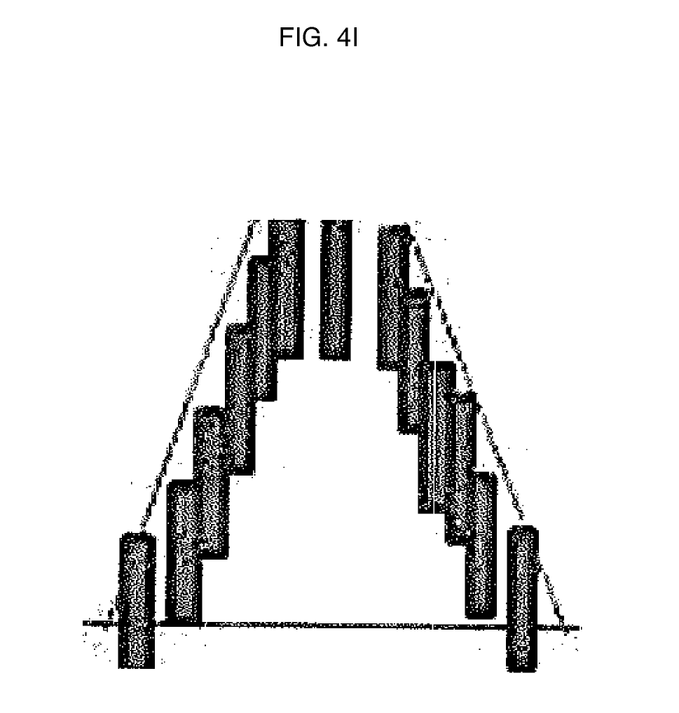

As illustrated in FIG. 4, FIGS. 4A to 4I are views showing massage operations of the vibrator which vibrates in different types according to output pulses outputted from the controller 140 to the drive 130. That is, the colored portions in the drawings are portions to which vibration of the vibrator is transmitted and the other portion is portion where the vibrator is stopped or not attached.

FIG. 4A shows a case where relatively strong vibration continues same intensity for a preset time, FIG. 4B shows relatively strong vibration of same intensity repeated every preset short time interval, and FIG. 4C shows relatively strong vibration of same intensity repeated for a preset time every short time interval. Moreover, FIG. 4D shows visually weak vibration being gradually stronger for a preset time after starting and FIG. 4E shows strong vibration being gradually weakening for a preset time after starting contrary to the case of FIG. 4D. FIG. 4F shows early weak vibration is gradually stronger to the peak and is gradually weakened again. The description for the rest drawings, FIGS. 4G to 4I is omitted.

Return to FIGS. 2 and 3, the battery 150 is installed on the supporting plate 160 and supplies electric power to the drive 130 and the controller 140 through the power connecting member 170. The battery 150 may be inserted into a battery hole 160b formed in the supporting plate 160 so as to reduce the overall thickness of the vibration module for skin massage 100 and its description is omitted because this is substantially identical to the insertion of the vibrator 120 into the vibrator holes 160a.

The supporting plate 160 is provided to connect the printed circuit board 110 to the battery 150 integrally. The supporting plate 160 may be made of a flexible material such that flexibility of the vibration module for skin massage 100 can be guaranteed. Moreover, the supporting plate 160 may be configured such that the battery 150 and the vibrator 120 are mounted at the ends in the major axis on an oval side of the supporting plate 160, respectively. Thus, devices are not mounted at the middle portion of the major axis and due to this the supporting plate 160 can exhibit elasticity and higher flexibility.

The power connecting member 170 electrically connects the power terminals (not shown) of the battery 150 to the power terminals (not shown) of the drive 130 on the printed circuit board 110. In other words, the drive 130 receives electric power from the battery 150 through the power connecting member 170. Moreover, the power terminals of the printed circuit board 110 may supply electric power to the controller 140 and in this case the printed circuit board 110 has circuit patterns connecting the power terminals to the drive 130 and the controller 140 in parallel.

The insulator 180 is attached to a contact area between the power terminals of the battery 150 and the power connecting member 170. That is, the insulator 180 is attached to the battery 150 to interrupt the electrical connection between the power terminals of the battery 150 and the power connecting member 170 and the electrical connection between the power terminals of the battery 150 and the insulator 180 is made when the insulator 180 is separated from the battery 150. The insulator 180 is detachably attached to the battery 150 and controls the electrical connection between the power terminals of the battery 150 and the power connection member 170 through the attachment and detachment of the insulator 180 to control the electric power to be supplied from the battery 150 to the drive 130 or not.

In other words, the insulator 180 can switch the electrical connection between the power terminals of the battery 150 and the power connecting member 170 and in this case the vibration module for skin massage 100 can spend the electric power of the battery 150 only by the switching function of the insulator 180 even without a separated switch. That is, omission of the switch allows reduction of volume of the vibration module for skin massage 100 and the electric power of the battery 150 may be spent only when the vibrator 120 is operated.

Although in this exemplary embodiment a thin sheet of the insulator 180 is detachably attached to the battery 150 to screen the power terminals, the present invention is not limited thereto but the insulator 180 may be attached to and detached from power terminal regions of the battery 150 and may be modified under the conditions of applying electric power between the power terminals of the battery 150 and the power connecting member 170.

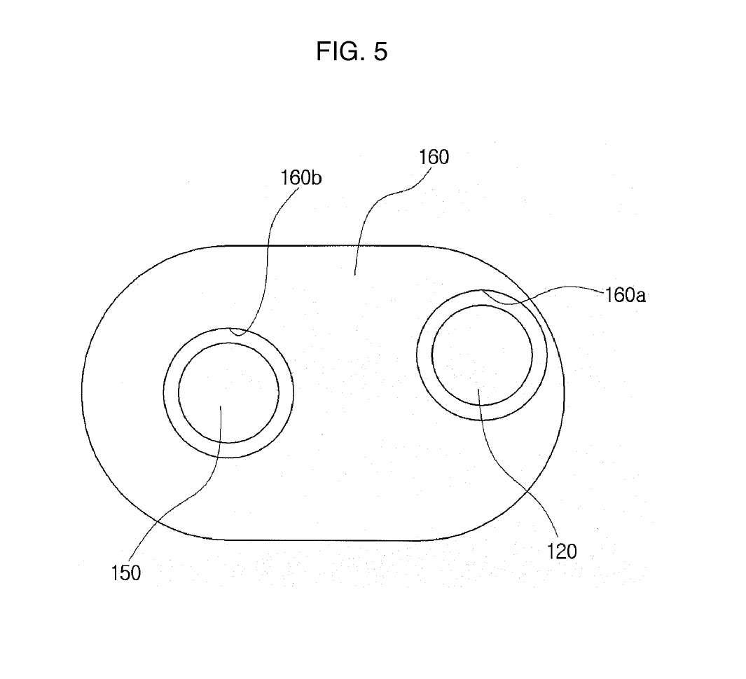

FIG. 5 is a rear side view of the vibration module for skin massage according to the exemplary embodiment of the present invention in which the battery 150 and the vibrator 120 are inserted into the battery hole 160b and the vibrator holes 160a that are formed in the printed circuit board 110 and the supporting plate 160 and are fixed thereto. A buffering pad (not shown) may be attached to the rear side of the vibration module for skin massage 100 (the rear side of the supporting plate) and may prevent direct contact between the vibrator 120 and human skin. In FIG. 5, the buffering pad is omitted for the purpose of showing the battery hole 160b and the vibrator holes 160a and ones of sides of the battery 150 and the vibrator 120 which are inserted thereinto. Moreover, the buffering pas may be made in various types such as nonwoven fabric or a sheet containing liquid material.

As described with reference to FIGS. 2 to 5, the vibration module for skin massage 100 is configured such that the printed circuit board 110 on which the vibrator 120 and the drive 130 thereof and the controller 140 of the drive 130 are installed and the battery 150 are integrally attached to the flexible supporting plate 160, so that volume and thickness of the vibration module can be minimized and flexibility thereof can be guaranteed and vibration of the vibrator 120 is transmitted to the human skin through vibration of the whole vibration module so that the vibration can be transmitted to a relatively wide area on the human skin in comparison to the size of the vibrator.

In addition, various vibrations of the vibrator 120 such as rubbing, picking, pressing, and knocking similar to massage carried out by human hands, in addition to the simple strong and weak vibrations, can be generated to improve skin massage effect by a controller 140 controlling the drive 130 of the vibrator 120 using pulse width modulation (PWM).

Furthermore, the vibration module for skin massage secures flexibility thereof to be easily bent along the contour of user's face and to be closely attached to the face resulting in improving transmission of vibration to the skin.

Furthermore, a vibration transmission region is relatively increased due to transmission of vibration through whole the vibration module and overall volume thereof is relatively reduced, resulting in improving mobility.

While this invention has been particularly shown and described with reference to preferred embodiments thereof, these embodiments are provided so that this disclosure will be thorough and complete, and will fully convey the concept of the invention to those skilled in the art. It will be understood by those skilled in the art that various changes in form and details may be made therein without departing from the spirit and scope of the invention as defined by the appended claims.

What is claimed is:

1. A vibration module for skin massage, comprising:
a printed circuit board;
a vibrator installed on the printed circuit board;
a drive mounted on the printed circuit board to provide vibration force of the vibrator when electric power is supplied;
a controller controlling the drive to control the vibration of the vibrator;
a battery supplying the electric power to the drive and the controller;
a supporting plate integrally connecting the printed circuit board to the battery;
a power connecting member electrically connecting power terminals of the battery to power terminals of the drive mounted on the printed circuit board; and
an insulator attached to a contact area between the power terminals of the battery and the power connecting member to allow contact between the power terminals and the power connecting member at the separation from the battery.

2. The vibration module of claim 1, wherein the supporting plate is made of flexible material.

3. The vibration module of claim 2, wherein the battery and the vibrator are mounted at the ends in the major axis on an oval side of the supporting plate, respectively to be fixed on the supporting plate and to increase flexibility of the vibration module.

4. The vibration module of claim 1 wherein the controller controls the drive in pulse width modulation such that at least two different pulses are outputted to the drive, wherein the at least two different pulses are sequentially outputted by a preset reference or only one of the at least two different pulses is outputted continuously.

5. The vibration module of claim 1, wherein the printed circuit board has battery holes and a vibrator hole for insertion and fixing of the battery and the vibrator, and
at least a part of the battery is inserted into and fixed in the battery holes and at least a part of the vibrator is inserted into and fixed in the vibrator hole.

6. The vibration module of claim 1, wherein the printed circuit board has power terminals for supplying electric power to the drive.

7. The vibration module of claim 1, wherein the insulator is made in the form of a sheet and is detachably attached to the battery to screen the power terminals.

8. The vibration module of claim 1, further comprising a buffering pad attached to a side of the supporting plate to prevent direct contact between the vibrator and the human skin.

9. The vibration module of claim 1, wherein the printed circuit board comprises a flexible printed circuit board (FPCB).

10. The vibration module of claim 1, wherein the drive comprises one of a vibration motor, a solenoid, a piezo device, and a linear vibrator.
